(19) United States
(12) Patent Application Publication
(10) Pub. No.: US 2013/0080437 A1
(43) Pub. Date: Mar. 28, 2013

(54) SYSTEM AND METHOD FOR PROVIDING STATISTICS FOR USER SUBMISSIONS

(71) Applicant: Maxime Marcel Rassi, Boston, MA (US)

(72) Inventor: Maxime Marcel Rassi, Boston, MA (US)

(21) Appl. No.: 13/625,142

(22) Filed: Sep. 24, 2012

Related U.S. Application Data
(60) Provisional application No. 61/538,296, filed on Sep. 23, 2011.

(51) Int. Cl. G06F 17/30

(52) U.S. Cl. 707/737; 707/758; 707/754; 707/748; 707/E17.014; 707/E17.089; 707/E17.059

(57) ABSTRACT

Systems and methods for providing an overview of user comments are disclosed. In one example, the method includes receiving the user comment, processing words in the user comments by comparing each of the words in the user comments with a plurality of words in a wordlist, determining whether each word from the wordlist is used in the user comments, calculating statistics on the user comments based on a number of times each word from the wordlist is used and transmitting the statistics for display to a user.

### RELATED APPLICATIONS

This application claims priority under 35 U.S.C. §119(e) to U.S. Provisional Application Ser. No. 61/538,296, entitled “SYSTEM AND METHOD FOR PROVIDING STATISTICS FOR USER SUBMISSIONS,” filed on Sep. 23, 2011, which is hereby incorporated herein by reference in its entirety.

### BACKGROUND

There are many websites that allow users to post comments in response to a message, article, blog, question or poll. For example, many medical websites allow users to post questions to which other users can respond. In one example, CNN (www.cnn.com) allows readers to post comments in response to online articles. In another example, Zoomerang (www.zoomerang.com) allows pollsters to post questions and users may select a response to a poll and also post comments in response to particular questions. In another example, Medscape (www.medscape.com) allows users to comment on medical articles and editorials. In an additional example, there are website forums where users post comments on all types of topics, such as movies, television episodes, and local businesses or chains.

### SUMMARY

Unfortunately, when multiple comments are posted in response to a message, question, article, blog or poll, it is often too tiresome or time-consuming for new users to read all the comments. Thus, it may be difficult for a new user to gain a sense for the general opinion of others without having to review multiple comments. It is appreciated that some websites provide a rating system, where products or experiences are rated with one or more stars based on the level of user satisfaction. The star rating system in many cases may provide useful summary for users. However, in other cases, the rating system may not provide a summary that is relevant to the nature of the product or service. For instance, rating a car on a five star rating may not provide a complete picture for a user having multiple criteria in desiring to purchase that car. For example, the car rating provided by users has to deal with many different factors and not all factors have the same weight for different users. Some users might put more value on fuel efficiency, others on looks or price. Therefore, averaging a five star user rating system where each rating is based on the user's subjective meaning of importance may not be a meaningful summary.

In addition, some websites allow for fine-tuning a user's search and provide for searching for products and articles. However, these websites may not provide the fine tuning searching functionality for comments, forcing the user to review all the comments to find the relevant information.

Therefore, it is appreciated that it may be beneficial to provide users with an application that analyzes the comments of other users and provides a summary of user comments. In one embodiment, a comment analytics application may be provided to operate on a particular webpage and analyze comments on that webpage. In at least one example, the comment analytics application may be integrated into a website to provide an analysis of comments on the webpage to users. In one example, the comment analytics application completes a word analysis on each comment and compiles generic statistics on the overall user response. According to one feature, one or more predetermined sets of words are assigned a mood value, and an overall mood value is displayed based on the frequency of words having different values. According to another feature, each predetermined set of words is correlated with a positive or negative value.

Accordingly, the system described herein, in various embodiments, analyzes the most straightforward human input, compiles the user opinion in words, and displays a summary that provide for much more meaningful review analysis. Such a summary allows the user to understand the content of the reviews without individually reading each of them. Further, the system described herein, may further allow for the user to fine-tune or filter the results to view only the reviews of particular interest to the user. For examples, search for “fuel efficiency,” or “style,” and only view the comments or reviews with those keywords.

According to one embodiment, a computer-implemented method for providing an overview of user comments is disclosed. In one example, the method comprising the acts of receiving the user comments, processing, by a computer system, words in the user comments by comparing each of the words in the user comments with a plurality of words in a wordlist, determining whether each word from the wordlist is used in the user comments, calculating statistics on the user comments based on a number of times each word from the wordlist is used, and transmitting the statistics to a device.

In one example, the method further comprises the acts of receiving from a user an entry of at least one word, filtering the user comments based on the at least one word, and transmitting to the device a percentage of user comments including the at least one word. In addition, each word in the wordlist may be assigned a mood value. Further, the plurality of words in the wordlist may be grouped into sets based on the mood value and each set is assigned one of a word impression value. In one example, calculating statistics includes determining a plurality of most frequent mood values based on the mood value of each word in the user comments.

In another example, calculating statistics includes determining a ranking of the number of times each word from the wordlist is used in the user comments. In yet another example, calculating statistics includes calculating an overall comment impression based on a percentage of words in the user comments with a positive impression value and a percentage of words in the user comments with a negative impression value. In a further example, the method further includes analyzing the words in the user comments according to at least one of word context rules and punctuation rules. In one example, the method further comprises displaying the statistics to the user.

According to another embodiment, a system for providing an overview of user comments is disclosed. In one example, the system comprises a database including a wordlist, a processor configured to compare each of the words in the user comments with a plurality of words in a wordlist, determine whether each word from the wordlist is used in the user comments, and calculate statistics on the user comments based on a number of times each word from the wordlist is used. The system may further comprise an interface configured to receiving the user comments and transmit the statistics to a device.

In one example, the system further comprises a user interface configured to allow a user to enter at least one word, and wherein the processor is configured to filter the user comments based on the at least one word and displays a percentage of user comments including the at least one word. In addition, each word in the wordlist may be assigned a mood value, the mood value stored in the database. The plurality of words in the wordlist may be grouped into sets based on the mood value and the sets are stored in the database. Further, the mood values may be assigned a word impression value.

In another example, the processor calculates statistics including a plurality of most frequent mood values based on the mood value of each word in the user comments. In yet another example, the processor calculates statistics including list of a plurality of words from the wordlist that are most frequently used in the user comments. In a further example, the processor calculates statistics including an overall impression based on a percentage of words in the user comments with a positive word impression value and a percentage of words in the user comments with a negative word impression value. Further, the statistics may be displayed to a user via the device. In one example, the processor is further configured to analyze the words in the user comments according to at least one of word context rules and punctuation rules.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example. References to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE FIGURES

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows an example of webpage including a user message board, with respect to which aspects of a system for analyzing comments are displayed according to an embodiment;

FIG. 2 shows a diagram of the system according to an embodiment;

FIG. 3 shows a flow chart of a method for providing an overview of user comments according to an embodiment of the invention;

FIG. 4 shows a flow chart of another method for providing an overview of user comments according to an embodiment of the invention;

FIG. 5 shows an example computer system with which various aspects of the invention may be practiced; and

FIG. 6 shows an example storage system capable of implementing various aspects of the present invention.

### DETAILED DESCRIPTION

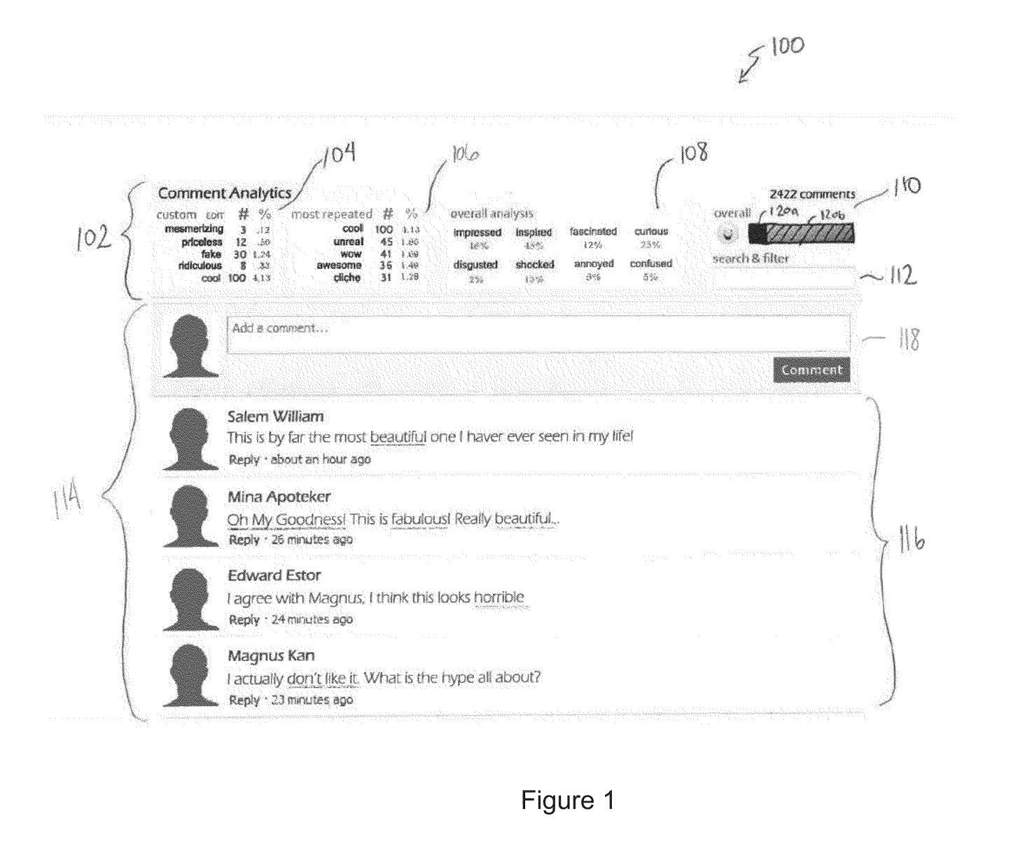

As discussed above, there exists a need for an application that analyzes the comments of users and provides a user comment summary. FIG. 1 shows a webpage that includes a user message board 114, according to an embodiment of the invention, with respect to which aspects of a system 100 may be practiced, and may be displayed in the form of a comment analytics bar 102. According to one aspect, the user message board 114 shows some exemplary comments 116, and the comment analysis shown in the comment analytics bar 102 includes analysis of many comments not shown in the user message board 114. According to one feature, the system 100 using the comment analytics bar 102 provides a statistical analysis of the posts on the message board 114. The system 100 analyzes the comments 116 on the message board 114 and displays the results of the analyses in the comment analytics bar 102.

In the illustrated example, the comment analytics bar 102 includes a user-customized word count box 104, a most-repeated word count box 106, a mood analysis box 108, an overall impression bar 110 showing positive versus negative overall impression, and a user search and filter text box 112. Each of the fields in the comments analytics bar 102 may be displayed based on different analyses performed by the system 100. Each field may provide a different metric which may be helpful to the user in understanding the nature of the comments.

According to one embodiment, the system 100 may provide analytics in the form of the comment analytics bar 102 for any webpage to analyze user comments. For instance, if the user is interested in buying a consumer electronics product with which the user is unfamiliar. The user may not know what criteria he or she is interested in besides overall quality of the product itself. Reviewing other user comments can start to unravel important issues such as, “battery requirements are as expensive as the product needs 4C batteries,” and “it's much bigger than expected.” The user may review these and decide that size and additional post purchase costs may be important issues in selecting this consumer product. In this example, the fields in the comments analytics bar 102 may show that the most-repeated word count box 106 displays “size,” “expensive,” and “battery.” The mood analysis box 108 may display “unexpected” and “too big.” Further, the overall impression bar 110 may display a bar that leans toward the negative side.

In one example, the system 100 can be implemented as an Internet Browser plug-in application. In another example, the system 100 can be included as part of the services provided by the webpage. In yet another example, the features of the system 100 may be accessed remotely as a service through an Application Programming Interface (API). In one example, the API can serve as an interface between the system 100 and various websites, software programs and interfaces and further facilitate their interaction.

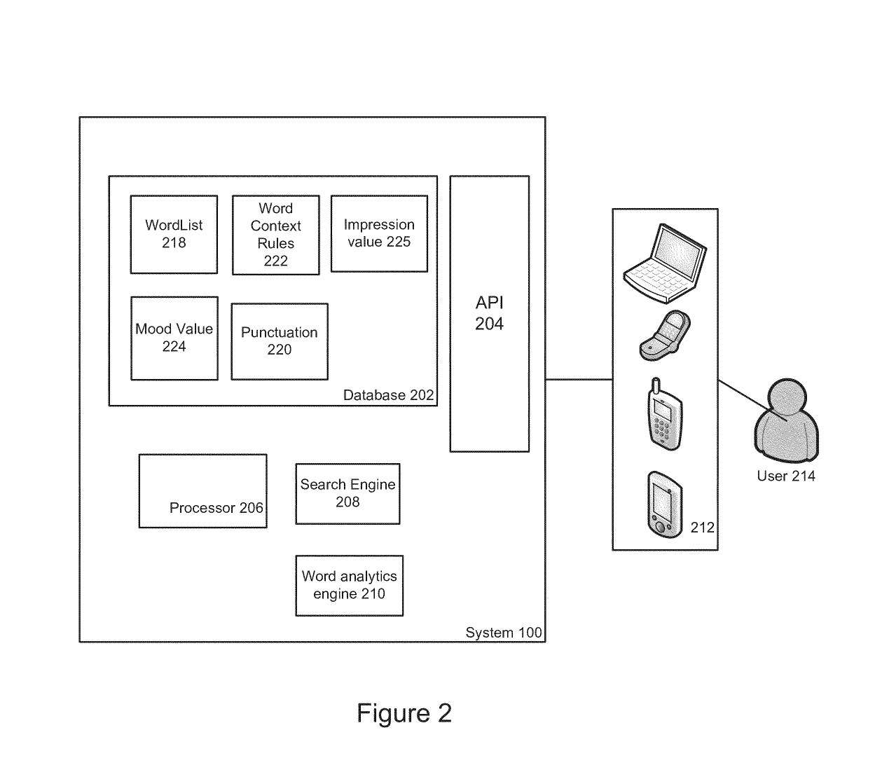

FIG. 2 shows an example of the system 100 according to various aspects of the present invention. In one example, the system 100 includes a database 202, the API 204, a processor 206, which may include a search engine 208, and an analytics engine 210. The database may include a word list 218, a punctuation list 220, word order rules 222, and mood values 224. The system 100 may receive and transmit information from one or more of the devices 212 operated by users 214.

According to one example, a user submits a comment on a webpage, such as the webpage shown in FIG. 1. In one example, the comment may be transmitted to the system located on a server hosting the webpage and may be stored in a database of the server. In other examples, the comment may be transmitted to the system 100 though the API and stored in the database 202. In one example, the system 100 processes the comment according to methods described below. The system 100 may process the comment in relation to the other comments stored in the database and entered by other users of the website. For example, the system 100 may perform indexing functions on a word by word basis and punctuation basis.

According to various examples, the system 100 may also perform a context search and analysis between words to determine the role of the word in the sentence, a relationship search and analysis between words. In some examples, the system 100 may perform a punctuation search and analysis, as described below. According to one feature, the analytics engine 210 of the system 100 determines whether any of the words in the comments are among those of a wordlist 218. In one example, the system 100 may determine the frequently used words within the comments 116 and calculate different statistics based on the words in the comments.

According to one feature, the analytics engine 210 of the system 100 determines the statistics within the comments 116 and the system 100 may display the statistics to the user via the comment analytics bar 102. In one example, the analytics engine 210 of the system 100 determines the number of the most frequently used words in the comments 116 and the system 100 displays the most-repeated word count box 106. In the illustrated example, the most-repeated word count box 106 of the comment analytics bar 102 shows the five most frequently used words in the comments 116. It includes a chart showing the word, the number of times it was repeated, and the percentage of comments in which the word was included.

According to one embodiment, the analytics engine 210 of the system 100 may analyze the context of the word before including it in the most repeated word count box 106. For example, if a comment uses the word “cool,” but the context is “not cool” or “this isn't cool,” it will not be included in the count of the number of times the word “cool” was repeated. In other embodiments, phrases are analyzed to determine the meaning of the phrase and not just words in the phrase. For example, “ridiculously amazing” may be distinguished from “amazingly ridiculous,” and each phrase may be correctly categorized. Additionally, in this example, “amazing” from the phrase “ridiculously amazing” will be included in the count of the number of times the word “amazing” was repeated, while “amazingly” will not be counted. Similarly, “ridiculous” from the phrase “amazingly ridiculous” will be included in the count of the number of times the word “ridiculous” was repeated, while “ridiculously” will not be counted. In other embodiments, all repetitions of the word are included in the count box 106.

In one example, the relationship search may add various levels of weight and create hierarchies of importance of different words used in the comments. For example, the system may weigh the word “excellent” higher than the word “good.” In these examples, the system 100, based on frequency and context of the words used in the comments, generates an overall summary, which may be transmitted and displayed to a user of the website. The processing and indexing of data may be re-computed after every comment submission from each user and may be stored in the database associated with the system 100. In this fashion, the summary information may be ready to be displayed for the next user that accesses the webpage.

In one example, words which may be used within the comments may be stored in a word list 218. The word list 218 stored in the database 202 may include positive, negative and neutral words, to which the words in the comments 116 can be compared. The word list 218 may be predetermined and accessed by the processor 206. In one example, the user can input one or more words to be added to the mood word list 218. As described below, the system 100 provides for the user to perform regular expression searches on the comments for more fine-tuned and user preferred interests. In one example, the system 100 can add the words used by the user in these searches to the wordlist.

The mood value 224 stored in the database 202 may be associated with each of the words in the word list 218. As described above, the mood value 224 may include one or more words associated with the one or more words from the word list. In addition, the word value may include word value sign such a positive, a negative or a neutral word value associated with each word. In at least one example, there may be multiple signs for each word. For example, the word curious may be positive, negative or neutral depending on the context; as in “i'm curious as to how you reached this conclusion exactly;” “i'm curious to find out how this plays out in the long run;” or “i'm curious to find out more information about this topic.” In one example, the system 100 uses the word context rules to determine the mood value of a word based on the sentence context.

In one implementation, as the user types a comment, fragments of a sentence in the comment, the sentence may be sent to the system 100 for real-time processing. The system 100 may transmit back approximate evaluation of the mood of the entered sentence as was interpreted by the system 100. The interpretation is displayed to the user, who can modify the sentence to reflect a matching mood. In one example, the interpretation of the mood may be displayed to the user using color representing different moods or through other metrics such as a meter bar or numeric representations. For example, the mood may be presented to the user as red to green to represent hate it to love it In one implementation, the words in the wordlist 218 may include a weight or a ranking. For example, the word “excellent” may be ranked higher than the word “good.” The system may use these levels of weight and create hierarchies of importance of different words used in the comments, producing and displaying different analyses based on those hierarchies.

The punctuation list 220 includes commonly used punctuation symbols, which the system 100 may use to analyze the comments 116 and to determine the repeated word count, the mood analysis and the overall impression analysis. In addition, the punctuation list 220 may include rules associated with the punctuation symbols. For example, the punctuation rules may distinguish the comment “Amazing? I think it's ridiculous!” from “Ridiculous? I think it's amazing!” based on the use of the question mark and exclamation point.

In another embodiment, the analytics engine 210 of the system 100 may also analyze the overall punctuation of comments to determining user reaction embedded in the user comments 116. For example, the comment “Amazing? I think it's ridiculous!” may be distinguished from “Ridiculous? I think it's amazing!” based on the use of the question mark and exclamation point. In this example, “amazing” from the phrase “Ridiculous? I think it's amazing!” will be included in the count of the number of times the word “amazing” was repeated, while “Amazing?” from that comment will not be counted. Similarly, “ridiculous” from the phrase “Amazing? I think it's ridiculous!” will be included in the count of the number of times the word “ridiculous” was repeated, while “Ridiculous?” from that comment will not be counted. In other examples, other punctuation may be analyzed to determine user reaction. The word context rules 222 may be associated with words in the wordlist 218. As described above, different words may have different meaning based on the context. The word context rules 222 may include rules regarding order words in the sentence, punctuation, word order, and may include other rules.

The words in the wordlist 218 of the system 100 may include a hierarchical relationship to other words based on context, which may be stored in the database. For example, in the context of consumer goods, tie in components such as batteries, filters or cartridges may increase the cost of the consumer good. In this context, when a user searches for the word “expensive” they may want to see comments pertaining to the tie-in goods. The analytics engine 210 may analyze the words in the comments 116 based on the hierarchy relationship determined by the system 100. For example if a user is reviewing car reviews, the system 100 may provide for the user to filter the comments based on keywords “expensive.” Based on the hierarchy relationship build in the system 100, relevant comments might be returned that include “fuel consumption,” “MSRP,” and “insurance.”

In another embodiment, the analytics engine 210 of the system 100 may analyze the mood associated with the comments. In one example, each comment may receive a positive, negative, or neutral overall impression value based on a mood value, and the analysis may include information on the percentage of positive, negative, and neutral comments within the comments 116.

According to one aspect, to determine the mood value associated with the comments, the analytics engine 210 may compare the words on the message board 114 with words from the wordlist 218. According to one embodiment, various phrases or expressions may be included as words in the wordlist 218. According to one embodiment, the words in the wordlist 218 are each assigned the mood value 224. In one embodiment, words in the wordlist 218 may be grouped into sets, and each set of words in the wordlist 218 may have the same mood value 224. In one example, the mood value is a word, such as “impressed” or “disgusted.” In various examples, the mood value words may be shown in the mood analysis box 108.

According to one feature, each mood value 224 correlates with a positive, neutral or a negative “mood.” The mood of each mood value word may be associated with a word impression value, which may be a positive, neutral or a negative impression value. In another example, words may be assigned more than one mood value, and each word is also assigned a positive or negative word impression value. For each comment, the analytics engine 210 may aggregate the word impression values to determine an overall comment impression value. As described below, the overall comment impression values may be counted and displayed in the overall impression bar.

In addition, the analytics engine 210 may determine the time, date and location associated with the comments 116 and in one example, the application may determine a correlation between the time of day the comments 116 were posted and the mood associated with the comments, as described above. In one example, the user may select the time period for which to display the mood value information. The time and day may be displayed on the webpage including the comments 116. The system may use the time, date and location information to rank or weigh different comments based on the importance of those comments. For example, a comment posted during lunch time may be associated with a higher or lower weight in comparison with a comment posted at midnight. In addition, different weight may be assigned based on more recent comments as they may be the most relevant. In another example, different weight may be assigned to comments based on the proximity of the location to the user reviewing the comments.

In another example, the time and date of the comments can be used to rank or weigh the comments based on time associated with related current events. For example, an article about the latest version of a popular mobile phone was released a day before an official announcement. The mobile phone may have many very passionate fans and equally passionate critics of the phone writing comments to the article. Depending on the time the article is released, the users posting soon after the release may either one of the biases. The system 100 can adjust the weight of the comment taking into account how soon after the article was published and the comment was posted.

Referring again to FIG. 1, the comment analytics bar 102 also includes the mood analysis box 108, which shows a result associated with a mood analysis of the user comments 116. In one example, the analytics engine 210 may determine the statistics displayed in the mood analysis box 108 based on the mood value 224 of the words used in the comments 116, as described above. As noted above, each of the words in the wordlist may be assigned a mood value, which represents the “mood” of the word, the mood value may be stored in the database. One or more words may be assigned the same mood value. For example, the words “beautiful” and “fabulous” may both be assigned a mood value of “inspired.” The analytics engine 210 may analyze the words in the comments by comparing the words against the wordlist and determine the mood value associated with each of the words in the comments. For example, the use of the words “beautiful” and “fabulous” in the comments may be combined in the overall mood value of “inspired.” In other examples, many other words may be included in the mood value set “inspired.” The mood value words are displayed in the mood analysis box 108.

According to one embodiment, the analytics engine 210 may assign the words more than one mood value 224. For example, the analytics engine 210 may assign the word “beautiful” the mood values of “inspired” and “impressed.” In this example, some words may contribute more than once to the percentages in the mood analysis box 108. It is appreciated that any number of mood values may be assigned to any number of words.

In the illustrated example, the mood analysis box 108 shows eight different mood values, and the percentage of comments that include words that fall within each mood value. As shown in FIG. 1, the mood analysis box 108 includes four positive mood values (impressed, inspired, fascinated and curious) and four negative mood values (disgusted, shocked, annoyed and confused). In other examples, the mood analysis box 108 may include any number of mood values. In one embodiment, the analytics engine 210 determines, and the mood analysis box 108 displays, the most frequently expressed mood values (those with the highest percentage of comments that include words that fall within the mood value). In another embodiment, the mood values displayed in the mood analysis box 108 may be selected by a user from a predetermined set of mood values, the analytics engine 210 may process the comments 116 based on the user selected mood values and display analyses based on the user selection. The predetermined set of mood values may be stored in the database 202.

According to one feature, the comment analytics bar 102 also includes the overall impression bar 110, which shows the comparative overall view of the comments 116. As described above, the analytics engine 210 may determine the overall impression by assigning the overall comment impression value 225 to each of the comments 116. According to one feature, the analytics engine 210 assigns each comment an overall positive, negative or neutral value, depending on the words used in the comment.

In one example, the analytics engine 210 may determine an overall percentage of the total comments that are positive or negative. In at least one example, the analytics engine 210 may determine an overall percentage of neutral comments. The overall impression bar 110 can display the overall percentage of total comments that are positive versus the overall percentage of total comments that are negative. According to one embodiment, the analytics engine 210 may determine the percentage of comments 116 by totaling the number of comments that include positive words, the number of comments that include negative words, and the number of total words included in each comment. In addition, the overall impression may be determined based on the context rules determining the context of the words in the sentence. In other examples, the overall impression may be determined based on punctuation, time, date, location, weight or ranking of the word or the comment. Any other factors may determine the overall impression of the comment including length of the comment, or time the user spent drafting the comment. It is appreciated that any combination of these factors may be used to determine the overall impression.

As shown in FIG. 1, the overall impression bar 110 includes a small negative impression portion 120a and a large positive impression portion 120b indicating that the majority of comments on the message board 114 were positive. According to one embodiment, the analytics engine 210 determines the percentage of comments 116 that include positive words and the percentage of comments that include negative words and may further determine a positive score and a negative score associated with the comments.

In accordance with one example, the overall impression bar 110 shows the percentages of comments 116 having words with positive versus negative word impression values. According to another embodiment, the overall impression bar 110 shows the percentage of total words used in the comments 116 that have a positive word impression value versus the percentage of words used in the comments 116 that have a negative word impression value.

According to one feature, the overall impression bar 110 includes an icon indicating the overall mood of the comments. For example, if most comments are positive, the icon will show an icon with a positive facial expression, such as a smiling face. In another example, if most comments are negative, the icon will show an icon with a negative facial expression, such as a frowning face. In a further example, if the comments are approximately half positive and half negative, the icon will show an icon with a neutral facial expression. The icon may provide a visual indicator for the user to quickly understand the general nature of the comments without having to read all of them.

According to one aspect, the comment analytics bar 102 includes a user-customized word count box 104. The analytics engine 210 of the system 100 determines the number of times certain user-selected words were used in the comments 116, as well as the percentage of comments that used each user-selected word. The system 100 can display the number and percentage in the user-customized word count box 104. The words displayed in the user-customized word count box 104 may be selected by the user by providing a word input to the system 100. In one example, the word input may be provided via the interface of the webpage.

As shown in FIG. 1, the user-customized word count box 104 shows five user-selected words (mesmerizing, priceless, fake, ridiculous, cool). According to one embodiment, the user-customized word count box 104 may be customized according to user input to show any number of user-selected words. According to one feature, when a new user-selected word is added to the list, it may replace one of the previously user-selected words on the list.

According to another aspect, the system 100 may provide for the user search the comments for a word, phrase or pattern. The system 100 along with the comment analytics bar 102 may provide a user search and filter text box 112, which may be used by a user to enter a search input. The system 100 receives the search input from the user and the search engine 208 searches the comments 116 for the word, phrase or pattern entered in the user search and filter text box 112. In this example, the system 100 then displays only the comments that include the inputted word, phrase or pattern to the user. In one example, a pattern may a regular expression or a sequence of words. According to one embodiment, instead of using the user search and filter text box 112, a user may select a word in the user-customized word count box 104, and the system 100 filters the comments so that only comments including the selected word are displayed.

According to one embodiment, the system 100 may accept one or more of advanced search terms from a user. The system 100 may receive and analyze the advanced search terms according to one or more established advanced search term rules. For example, a user may enter the term (beautr[̂\]+) to search for comments including any words that begin with “beaut.” The system 100 may receive this advanced search term and analyze the search term according to the established rules and return comments including any words that begin with “beaut,” which may then be displayed to the user. In another example, a user may enter the term (beaut*) to search for comments including any words that begin with “beaut”. In a further example, a user may request that comments be searched for synonyms of the search term by entering, for instance a “˜” before the search term. In another example, a user may search for comments that include either of two words by including the word “OR” between the words. According to various embodiments, any other advanced searching strategies may be used.

As described above, the features of the system 100 may be provided via the custom analytics bar 102 on a webpage to analyze user comments. The custom analytics bar 102 may be displayed on top of any existing webpage to analyze user comments. In other examples, the custom analytics bar 102 may be added by a user to analyze comments on a website. Alternatively, features of the system 100 may be installed by the website provider as part of the back end services, and provided on a webpage that includes user comments. According to one feature, when the system 100 is installed by the website provider as part of a webpage, the custom analytics bar 102 may be automatically displayed to users of the website.

According to various embodiments, the custom analytics bar 102 may be displayed on one of the devices 212. According to some examples, the devices may include a desktop computer, a laptop computer, a tablet computer, a cellular phone, a feature phone or a smart phone. According to one embodiment, the system 100 is configured as a smart phone application on one of the devices 226, through which a user may submit information and retrieve data, and the comment analytics bar 102 may be applied to application website accessed via the smart phone.

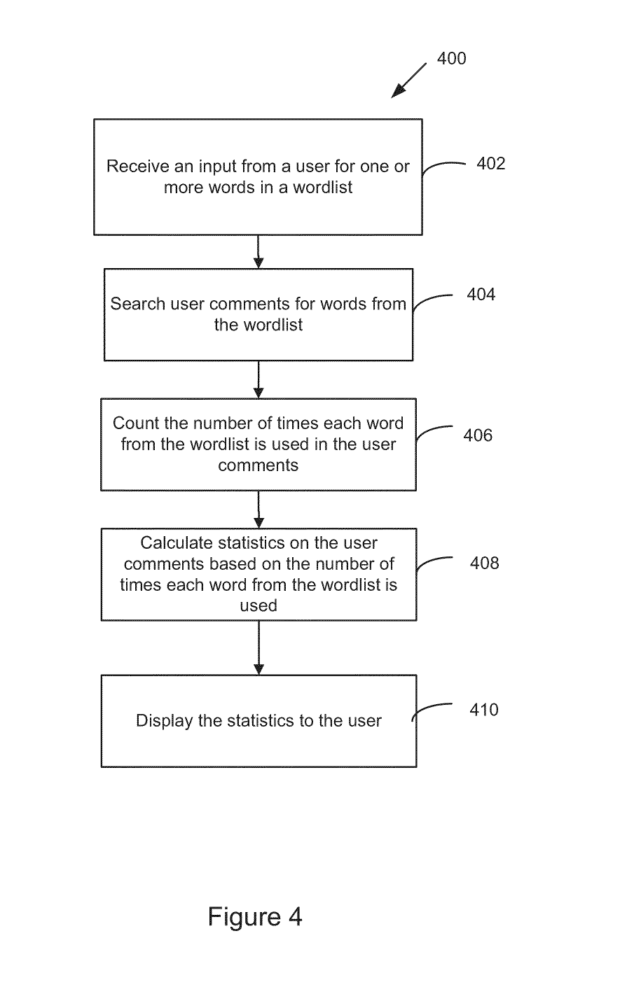

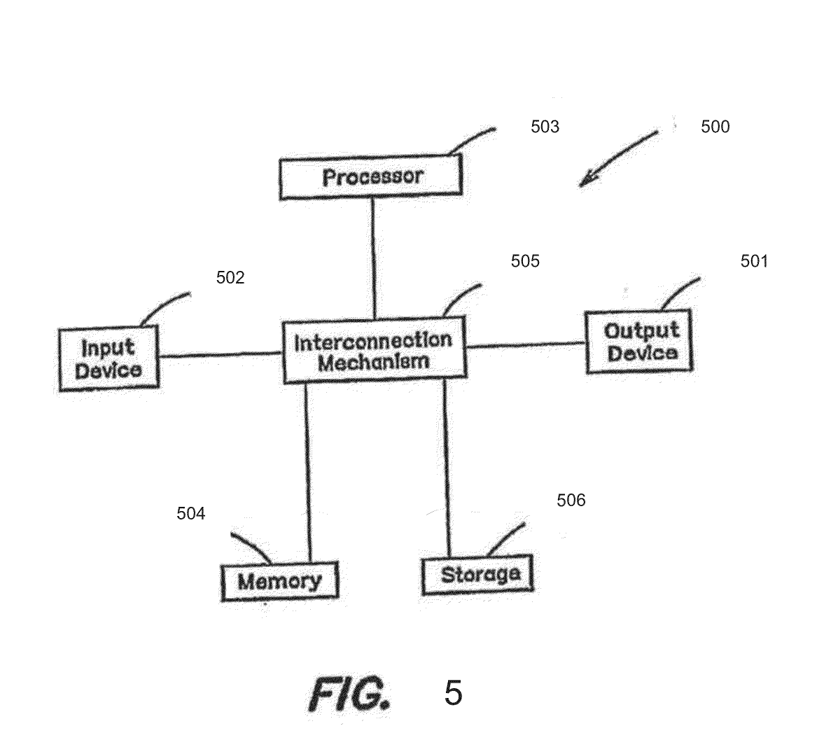

In one example, the system 100 may be implemented locally on one of the devices 212. In another example, the system 100 may be implemented as a cloud-based computing platform, such as the EC2 platform, available from Amazon.com, Seattle, Wash. However, it should be appreciated that other platforms and cloud-based computing services may be used. According to various examples, the system 100 may include a variety of hardware and software components configured to perform the functions described below with reference to FIGS. 4 and 5. These examples are not limited to a particular hardware component, software component or a particular combination thereof.

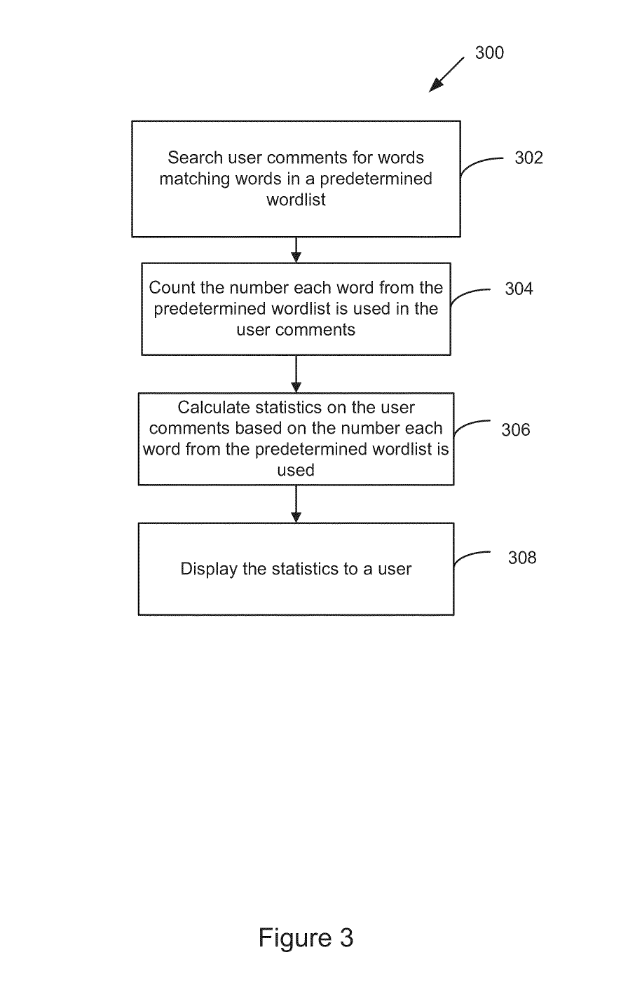

FIG. 3 shows a flow chart of a method 300 for providing an overview of user comments according to an embodiment of the invention. At step 302, user comments on a webpage are searched for words from a predetermined word list 218. As described above, according to one feature, each word in the wordlist is assigned a mood value 224. In one example, the mood value 224 may either a positive, a neutral or a negative value. The words in the user comments are compared with the words in the wordlist 218, to determine if any of the words in the comments match the words in the wordlist 218. At step 304, the number of times each word from the predetermined wordlist is used in the user comments is counted. At step 306, statistics on the user comments are calculated. The statistics are based on the number of times each word from the predetermined wordlist is used in the user comments. The statistics may be stored in the website server, locally on a device or remotely in a cloud-based computing platform. As described above, the statistics may include statistics on frequently used words, statistics on mood analysis, and overall impression statistics as described above. It is appreciated that other statistics may be calculated. At step 308, the statistics are displayed on the display screen of one of the devices.

According to one embodiment, the method for providing an overview of user comments also includes the steps of providing for a user to enter one or more words, and receive results based on the input words. In one embodiment, the method may include the steps of filtering the user comments based on the words entered by the user, and displaying user comments including the one or more words entered by the user. According to one feature, the method includes the steps of calculating statistics for the user selected word. And in some embodiments, the statistics for the selected word may have been previously calculated and stored remotely from the device used by the user, and may be transmitted to the user display at the user request. In other embodiments, the statistics the user requests are calculated by the system 100, which may be included in a website server and can be transmitted to the user device and displayed to the user on the device display screen.

According to one embodiment, the words in the predetermined wordlist may be grouped into sets based on mood value. In one example, each set may be assigned either a positive or negative value. As described above, calculating statistics may includes calculating frequently used words in the user comments by comparing the words in the comments with words in the predetermine wordlist. In a further embodiment, calculating statistics may include determining the most frequent mood values based on the mood value of each word in the user comments. In another embodiment, calculating statistics may include determining an overall user impression based on the percentage of words in the user comments with a positive value and a percentage of words in the user comments with a negative value.

FIG. 4 shows a flow chart of a method 400 for providing an overview of user comments according to an embodiment of the invention. At step 402, one or more words are entered by a user and received by the system. In one example, the user entered words may be added to a user wordlist. At step 404, user comments on a webpage are searched for words from the user wordlist. At step 406, the number of times each word from the user wordlist is used in the user comments is counted. At step 408, statistics on the user comments may be calculated based on the number of times each word from the wordlist is used. According to one embodiment, the statistics are calculated by the system 100, which may be included in the website server. At step 410, the statistics are displayed on one of the devices used by the user. According to one feature, the words in the user provided wordlist are grouped into sets based on mood value and each set is assigned one of a positive or negative value.

According to one embodiment, calculating statistics includes providing a list showing the words from the user wordlist that are most frequently used in the user comments. According to another embodiment, calculating statistics includes determining the most frequent mood values based on mood value of each word in the user comments. According to a further embodiment, calculating statistics includes calculating an overall impression based on a percentage of words in the user comments with a positive value and a percentage of words in the user comments with a negative value.

### EXAMPLE COMPUTER IMPLEMENTATIONS

Processes described above are merely illustrative embodiments of systems that may be used to create and manage a comment analytics system according to various aspects of the present invention. Such illustrative embodiments are not intended to limit the scope of the present invention, as any of numerous other implementations for performing the invention. None of the claims set forth below are intended to be limited to any particular implementation, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML, CSS or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of the system 100, each of the components may reside in one or more locations on the system. For example, different portions of the components of the system 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

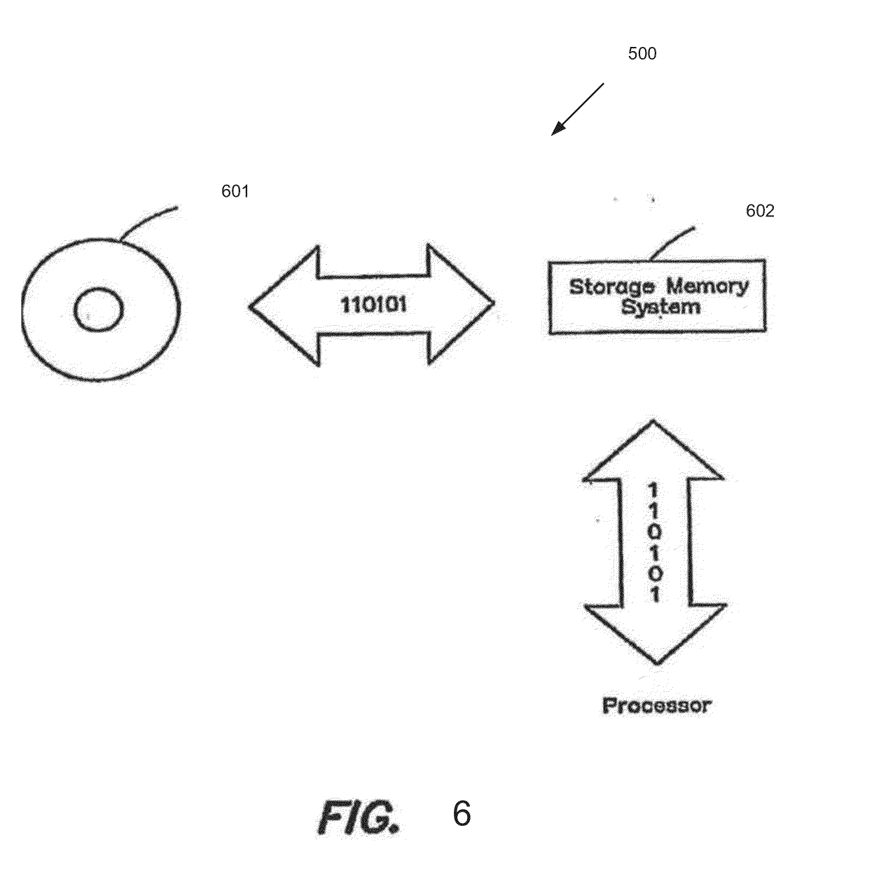

Any number of systems of the system described herein may be implemented on a computer system described below in relation to FIGS. 5 and 6. In particular, FIG. 5 shows an example computer system 500 used to implement various aspects. FIG. 6 shows an example storage system 600 that may be used.

System 500 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate determining and providing statistics with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 500 such as that shown in FIG. 5. The computer system 500 may include a processor 503 connected to one or more memory devices 504, such as a disk drive, memory, or other device for storing data. Memory 504 is typically used for storing programs and data during operation of the computer system 500. Components of computer system 500 may be coupled by an interconnection mechanism 505, which may include one or more busses (e.g., between components that are integrated within a same machine) and/or a network (e.g., between components that reside on separate discrete machines). The interconnection mechanism 505 enables communications (e.g., data, instructions) to be exchanged between system components of system 500. Computer system 500 also includes one or more input devices 502, for example, a keyboard, mouse, trackball, microphone, touch screen, and one or more output devices 501, for example, a printing device, display screen, and/or speaker. In addition, computer system 500 may contain one or more interfaces (not shown) that connect computer system 500 to a communication network (in addition or as an alternative to the interconnection mechanism 505).

The storage system 506, shown in greater detail in FIG. 6, typically includes a computer readable and writeable nonvolatile recording medium 601 in which signals are stored that define a program to be executed by the processor or information stored on or in the medium 601 to be processed by the program. The medium may, for example, be a disk or flash memory. Typically, in operation, the processor causes data to be read from the nonvolatile recording medium 601 into another memory 602 that allows for faster access to the information by the processor than does the medium 601. This memory 602 is typically a volatile, random access memory such as a dynamic random access memory (DRAM) or static memory (SRAM). It may be located in storage system 506, as shown, or in memory system 504, not shown. The processor 503 generally manipulates the data within the integrated circuit memory 504, 602 and then copies the data to the medium 601 after processing is completed. A variety of mechanisms are known for managing data movement between the medium 601 and the integrated circuit memory element 504, 602, and the invention is not limited thereto. The invention is not limited to a particular memory system 504 or storage system 506.

Although computer system 500 is shown by way of example as one type of computer system upon which various aspects of the invention may be practiced, it should be appreciated that aspects of the invention are not limited to being implemented on the computer system as shown in FIG. 5. Various aspects of the invention may be practiced on one or more computers having a different architecture or components that shown in FIG. 5.

Computer system 500 may be a general-purpose computer system that is programmable using a high-level computer programming language. Computer system 500 may be also implemented using specially programmed, special purpose hardware. In computer system 500, processor 503 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for providing an overview of user comments, the method comprising the acts of:
receiving the user comments;
processing, by a computer system, words in the user comments by comparing each of the words in the user comments with a plurality of words in a wordlist;
determining whether each word from the wordlist is used in the user comments;
calculating statistics on the user comments based on a number of times each word from the wordlist is used; and
transmitting the statistics for display to a user.

2. The computer-implemented method of claim 1, further comprising the acts of:
receiving from the user an entry of at least one word;
filtering the user comments based on the at least one word; and
transmitting to the user a percentage of user comments including the at least one word.

3. The computer-implemented method of claim 1, wherein each word in the wordlist is assigned a mood value.

4. The computer-implemented method of claim 3, wherein the plurality of words in the wordlist are grouped into sets based on the mood value and each set is assigned one of a word impression value.

5. The computer-implemented method of claim 3, wherein calculating statistics includes determining a plurality of most frequent mood values based on the mood value of each word in the user comments.

6. The computer-implemented method of claim 1, wherein calculating statistics includes determining a ranking of the number of times each word from the wordlist is used in the user comments.

7. The computer-implemented method of claim 1, wherein calculating statistics includes calculating an overall comment impression based on a percentage of words in the user comments with a positive impression value and a percentage of words in the user comments with a negative impression value.

8. The computer-implemented method of claim 1, further comprising analyzing the words in the user comments according to at least one of word context rules and punctuation rules.

9. The computer-implemented method of claim 1, further comprising displaying the statistics to the user.

10. A system for providing an overview of user comments, comprising:
a database including a wordlist;
a processor configured to:
compare each of the words in the user comments with a plurality of words in a wordlist;
determine whether each word from the wordlist is used in the user comments; and
calculate statistics on the user comments based on a number of times each word from the wordlist is used; and
an interface configured to receive the user comments and transmit the statistics for display to a user.

11. The system of claim 10, further comprising a user interface configured to allow the user to enter at least one word, and wherein the processor is configured to filter the user comments based on the at least one word and display a percentage of user comments including the at least one word.

12. The system of claim 10, wherein each word in the wordlist is assigned a mood value, the mood value stored in the database.

13. The system of claim 12, wherein the plurality of words in the wordlist are grouped into sets based on the mood value and the sets are stored in the database.

14. The system of claim 13, wherein the mood values are assigned a word impression value.

15. The system of claim 12, wherein the processor calculates statistics including a plurality of most frequent mood values based on the mood value of each word in the user comments.

16. The system of claim 10, wherein the processor calculates statistics including list of a plurality of words from the wordlist that are most frequently used in the user comments.

17. The system of claim 10, wherein the processor calculates statistics including an overall impression based on a percentage of words in the user comments with a positive word impression value and a percentage of words in the user comments with a negative word impression value.

18. The system of claim 10, wherein the processor is further configured to analyze the words in the user comments according to at least one of word context rules and punctuation rules.

19. The system of claim 10, wherein the statistics are displayed to a user via the device.
